(19) United States
(12) Patent Application Publication
(10) Pub. No.: US 2015/0347353 A1
(43) Pub. Date: Dec. 3, 2015

(54) DOCUMENT LAYERING PLATFORM

(71) Applicant: DataOceans, LLC, Norcross, GA (US)

(72) Inventors: Mark Turner, Roswell, GA (US); Larry Buckley, Alpharetta, GA (US); Chien Hsiung, Suwanee, GA (US); Dave Hickson, Jupiter, FL (US); Thomas Buckley, Roswell, GA (US)

(21) Appl. No.: 14/613,909

(22) Filed: Feb. 4, 2015

Related U.S. Application Data
(63) Continuation-in-part of application No. 14/590,500, filed on Jan. 6, 2015.
(60) Provisional application No. 62/003,983, filed on May 28, 2014.

(51) Int. Cl. G06F 17/21; G06F 17/27; G06F 17/30; G06F 17/24

(52) U.S. Cl. CPC G06F 17/211; G06F 17/24; G06F 17/2705; G06F 17/30917

(57) ABSTRACT

Consistent with embodiments of the present disclosure, a Document Layering (DL) platform may enable a user to overlay a color layer and/or an interactive electronic layer on an existing legacy document. Such embodiments may begin by receiving a legacy document and a specification of layers to be added to the legacy document. The legacy document may include, for example, a PDF document. The specified layers may include, for example, color layer design or an interactive layer design. The DL platform may overlay the color design and/or interactive layer design upon the legacy document. Further, the DL platform may output an updated document comprised of the legacy document with the color layer and/or the interactive layer overlaid upon it.

### RELATED APPLICATIONS

Under provisions of 35 U.S.C. §119(e), the Applicants claim the benefit of U.S. Provisional Application No. 62/003,983, filed on May 28, 2014, which is incorporated herein by reference.

Related U.S. patent application Ser. No. 14/590,500, filed on Jan. 6, 2015 in the name of DATAOCEANS, LLC and entitled “Targeted Content Marketing Platform,” claiming priority to U.S. Provisional Application No. 61/925,475, filed Jan. 9, 2014, is hereby incorporated by reference in its entirety (hereinafter referred to as the '500 application).

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to electronic document editing.

### BACKGROUND

Businesses often provide form documents, such as statements, to their clients in either electronic or printed form. These documents may come in the form of electronic or printed PDFs. The PDFs may have been generated using customized templates. Such templates might contain various data fields that may be populated by, in some instances, accessing a related database. For example, a template for a client's monthly statement may populate the resulting document with the client's name, address, account number, balance, and the like.

Given the considerable time and expense it may take to design, develop and program such a template, many companies may use a given statement template for years, or even decades, as making small changes or modifications to a template may involve considerable time and expense. Consequently, many companies may be providing documents to customers that are not very modern looking. For example, they may lack colors, images, or in the case of electronic documents, they may lack interactive elements. Therefore, there is a need for a way to update legacy templates and documents, without having to recreate the entire template from scratch.

### BRIEF OVERVIEW

A document layering (DL) platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Consistent with embodiments of the present disclosure, a Document Layering (DL) platform may enable a user to overlay a color layer and/or an interactive electronic layer on an existing legacy document. Such embodiments may begin by receiving a legacy document and a specification of layers to be added to the legacy document. The legacy document may include, for example, a PDF document. The specified layers may include, for example, color layer design or an interactive layer design. The DL platform may overlay the color design and/or interactive layer design upon the legacy document. Further, the DL platform may output an updated document comprised of the legacy document with the color layer and/or the interactive layer overlaid upon it.

The color layer may include, for example, a framing color, a background color, a portion of text, an image, a barcode, a blank page, and a colored image to replace a black and white image. The interactive layer may include, for example, a response button, a video, an interactive onsert, an interactive messaging application, an interactive marketing application, a URL, and information.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates a flow chart of a method for providing a Document Layering (DL) Platform;

FIG. 3 illustrates an embodiment of a document prior to the application of the DL Platform;

FIG. 4 illustrates an embodiment of a document after the application of the DL Platform; and

FIG. 5 is a block diagram of a system including a computing device for performing the method of FIG. 2.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

I. Platform Overview

Consistent with embodiments of the present disclosure, a Document Layering (DL) Platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

The DL Platform may be used to add a “color layer” to printed or electronic statements and/or an “interactive layer” to electronic statements. The DL platform enables a user to add color and interactive elements to legacy statements. In this way, the DL platform may be used to convert legacy products to a more modernized product without requiring users to update and reprogram the legacy statements from scratch.

A DL platform consistent with embodiments of the present disclosure may simply “layer” color and interactive elements on top of the already existing document. The document may be, for example, but not limited to, a statement, invoice, or any other transactional document. A “color layer” may be comprised of color elements used to add color to existing content, such as, for example, framing and background color, or replacing black and white charts with colored versions. An “interactive layer” may be comprised of interactive elements used to add, for example, response buttons, video capabilities, interactive onserts (elimination of Inserts), interactive messaging, interactive marketing and the transformation of data into self-servicing hyperlinks and more detailed information.

Employing, at least in part, color and interactive layering, a DL platform consistent with embodiments of the present disclosure may enable, but not be limited to: the ability to draw on top of an existing PDF documents, the placing of a layout template on top of an existing PDF (rather than a blank document), the effective use of white space for additional content such as an address, a bar code, a video, targeted messaging or other content, the ability to add pages before and after existing pages in the document, and the ability to add navigation buttons to include all pages.

The DL platform may perform the layering of an existing document quickly, as in some instances it may not require the data with the document to be parsed. For example, previously parsed documents (e.g., existing document designs) may be used as templates, and these designs may be modified to be packaged for electronic delivery (eDelivery). The DL platform may enable a user to specify what elements are to be added, removed or modified on an existing design. Furthermore, the DL platform may enable all statement types to be enabled for eDelivery.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

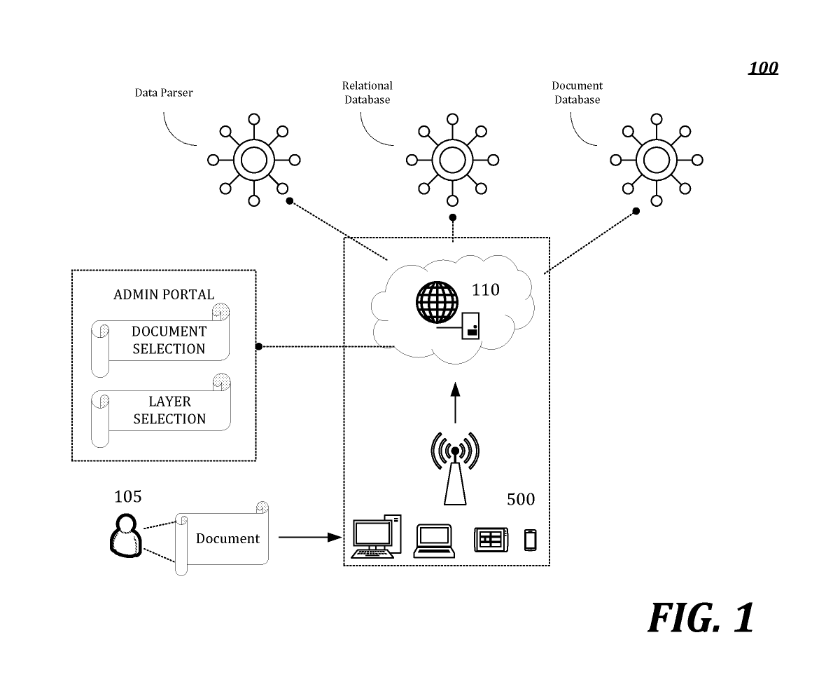

FIG. 1 illustrates one possible operating environment through which a platform consistent with embodiments of the present disclosure may be provided. By way of non-limiting example, a DL platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 500. One possible embodiment of the software application may be provided by the DataOceans VisualPDF™ suite of products and services provided by DataOceans LLC.

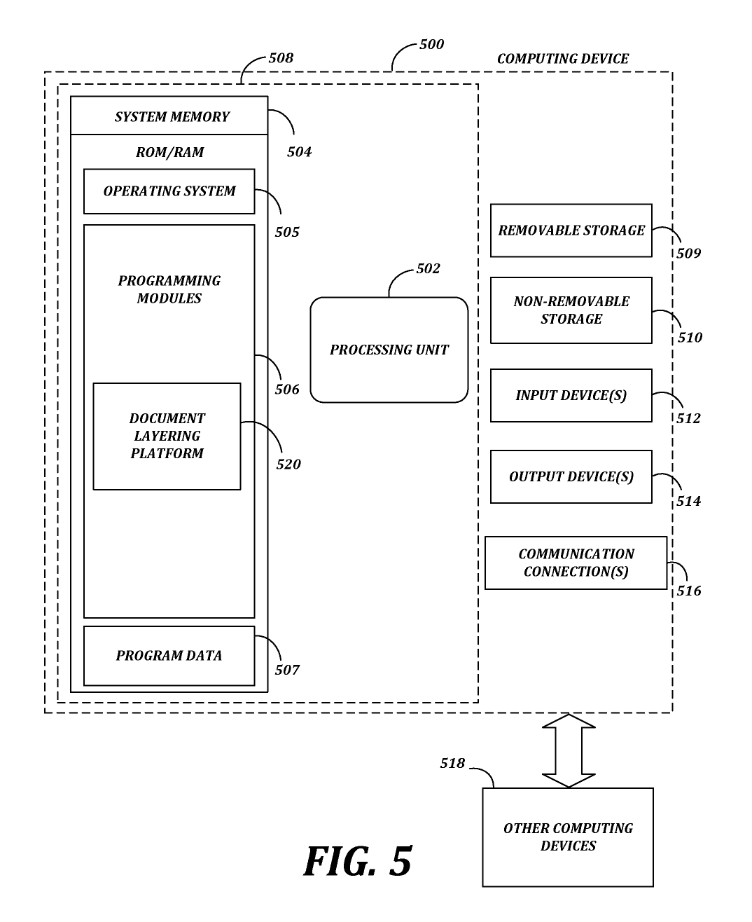

As will be detailed with reference to FIG. 5 below, the computing device through which the platform may be accessed may comprise, but not be limited to, for example, a desktop computer, laptop, a tablet, or mobile telecommunications device. As will be detailed with reference to FIG. 5 below, the computing device through which the platform may be accessed may comprise, but not be limited to, for example, a desktop computer, laptop, a tablet, or mobile telecommunications device.

Consistent with embodiments of the present disclosure, a DL platform may be comprised of, at least in part, a data parser, a relational database, a set of one or more document templates, and an admin user interface (UI). Details with regard to these components are provided in the '500 application, the disclosure of which is incorporated herein by reference. Together, these components may enable the customization of documents.

III. Platform Operation

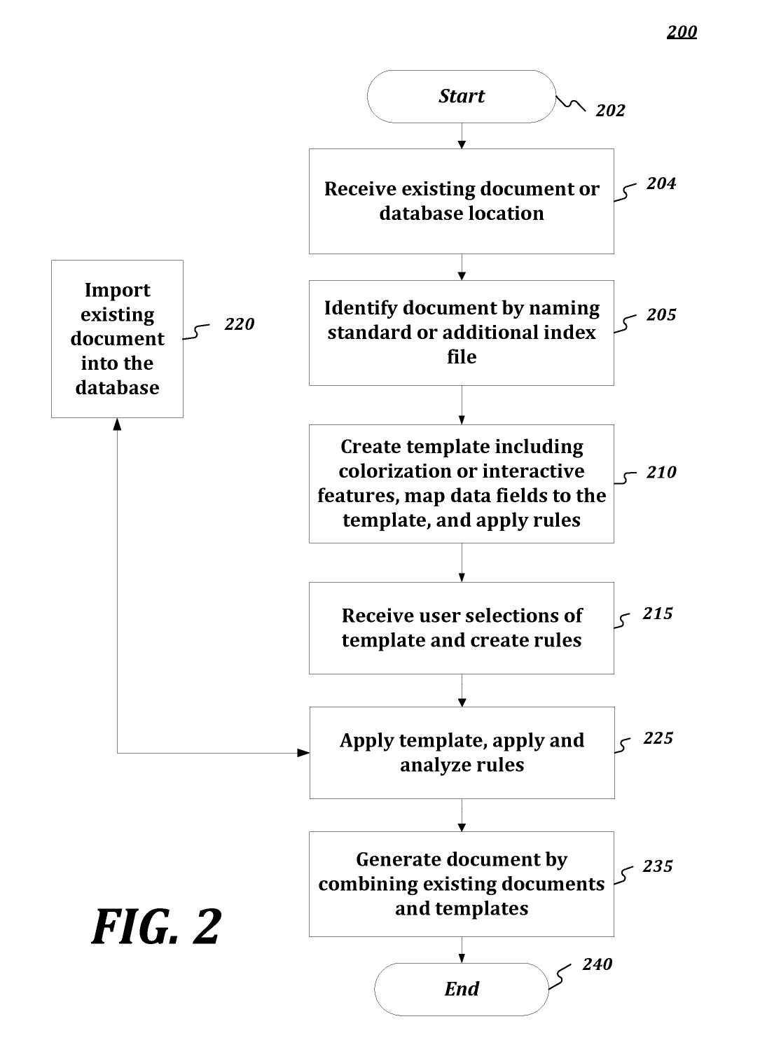

FIG. 2 is a flow chart setting forth the general stages involved in a method 200 consistent with an embodiment of the disclosure for providing DL platform 100. It should be understood that customization may also refer to individualization throughout this disclosure (i.e., customizing the document for a particular individual). Method 200 may be implemented using a computing device 500 as described in more detail below with respect to FIG. 5.

Although method 200 has been described to be performed by computing device 500, it should be understood that, in some embodiments, different operations may be performed by different networked elements in operative communication with computing device 500. For example, server 110 and/or computing device 500 may be employed in the performance of some or all of the stages in method 200. Moreover, server 110 may be configured much like computing device 500 and, in some instances, be one in the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may be implemented using a computing device as detailed in the Platform Design section of the present disclosure with reference to FIG. 5. The computing device may comprise memory storage having a set of instructions for providing and operating the DL platform installed thereon. The computing device may reside in a conventional networking environment. In various embodiments, the DL platform may reside in a cloud computing environment. In this way, the DL platform may be provided in either a conventional stand-alone software program, a web-application, or a plug-in for various existing software and hardware.

Method 200 may begin at starting block 202 and proceed to stage 204, where computing device 500 receives an existing document. The document may comprise, but not be limited to, a statement PDF. The statement PDF may be, for example, created by a Targeted Content Marketing (TCM) Platform disclosed in the '500 application and received therefrom. Although a statement PDF shall serve as the illustrative document for the DL Platform throughout the present disclosure, its use shall only be illustrative and not limiting upon the functionality of the DL Platform with other document types. Such documents may be accessed by the DL platform in a database.

The existing documents may be, for example, legacy statements that a user may desire to update with colorization or interactive elements. Method 200 may proceed to stage 205, where the DL platform may identify existing documents within the database by a file naming standard. In some embodiments of the present disclosure, the documents may be identified by one or more additional index files.

From stage 205, method 200 may advance to stage 210 where the DL platform may enable the creation of a statement template which may include colorization and/or interactive features. In some embodiments of the present disclosure, a template may be created using, for example, DataOceans VisualPDF. Such templates may be created by parsing and mapping the database documents accessed by the DL Platform.

In some embodiments, the DL platform may use a data parser to parse existing documents. The data parser may be operative to process data within the existing documents. Processing the data may comprise, but not be limited to, for example, identifying data file fields within the document and mapping the fields to a relational database. The relational database, in turn, may be accessed by the DL platform during the application of rules for integrating content into documents and/or layering documents. In some embodiments of the present disclosure, it may not be necessary to parse the existing documents, since, for example, they may have already been parsed upon its creation as a template (e.g., existing PDF). Data fields may be parsed and mapped onto the template and various rules may be applied as described in the '500 application, disclosing the parsing, mapping and modification of documents, the disclosure of which is incorporated by reference herein.

The DL platform may be operative to process an existing statement PDF to determine at least one placeholder region. The placeholder region may comprise, for example, the body, margins, various fields, and any white-space in the document. In turn, the DL platform may then update the existing statement PDF to include the at least one placeholder region. The placeholder region may be designated to receive content such as colorization or interactive elements.

Moreover, in some embodiments, method 200 may further comprise a sub-stage wherein the DL platform may be operative to map the document data fields to the parsed data in the relationship database. The mapping may also be based, at least in part, on the rules. In this way, a document comprising data fields may be populated with the content as well as the information residing the relational database (e.g., customer information). Mapping is further detailed the '500 application, the disclosure of which is incorporated by reference herein.

From stage 210, method 200 may proceed to stage 215 where the DL platform may receive user selections. In some embodiments, the user selections may be received from an admin portal. The admin portal may comprise an admin user interface (UI). The admin UI may be triggered in response to a user action. The user action may comprise, for example, a launching of a software or an access of a website associated with the DL platform. It should be understood that, in some embodiments, method 200 may begin with the provision of the admin UI.

In some embodiments, the triggering action (leading to the provision of the admin UI) may comprise a detection of printing or electronic communication of the document. Accordingly, the admin UI platform may be launched in response to, for example, a determination that the user has initiated a printing or other outbound communication stream associated with a document and or template. If the document in the print or communication stream has not been previously parsed by the DL platform, the DL platform may return to stage 205 to process the document.

The admin UI of the DL platform may enable the user to specify at least the following: a) an existing statement PDF for customization; b) content to be integrated into the document (such as colored elements or interactive elements); and c) criteria for integrating the content into the document.

Once the user has selected the existing statement PDF (or, for example, the PDF has been determined in the outbound communication stream), the admin UI may then enable the user to specify the content to be provided into the document. As mentioned above, the content may comprise, but not be limited to, for example, color layers, response buttons, video capabilities, interactive onserts (elimination of Inserts), interactive messaging, interactive marketing and data as hyperlinks.

The admin UI may provide the user with a plurality of input fields for specifying the content. In various embodiments, these input fields may be auto-populated by the DL platform based, at least in part, on the parsed data in the relational database, the document, and/or the set of rules as will be detailed below. The user may populate the input fields with a set of predetermined texts, graphics, and/or hyperlinks. The admin UI may enable the user to specify a “color layer” of the template that will be applied to the existing statement PDFs.

The “color layer” may be comprised of various regions of the template that will contain specified colors or designs. Furthermore, the admin UI may enable the user to specify an “interactive layer” of the template. The “interactive layer” maybe be comprised of the placement of various interactive elements at various locations of the template, as specified by the user. Interactive elements may include for example, but not be limited to, buttons, embedded videos, interactive onserts, messaging capabilities, interactive marketing and URLs. Detailed disclosure of an Admin UI is provided in the '500 application, the contents of which is incorporated by reference herein.

A URL may be direct to, for example, a local or remote server comprising additional content. In turn, the DL platform may be operative to embed the URL within the content and integrate the embedded content into the customized document. In this way, a viewer of the customized document may be provided with access to the additional content by, for example, clicking the targeted content within the document. Additional details of the insertion of targeted content is disclosed in the '500 application and incorporated by reference herein.

In some embodiments, the DL platform may determine rules based on data associated with the document such as, but not limited to, for example, metadata associated with the certain templates, file types, or an external data source associated with the templates. For example, the DL platform may be operative to establish rules that limit the dimensions of a particular text or image to be placed within a particular placeholder region of a document. These dimensions may be provided within, for example, the metadata associated with the document. Said metadata may be established during document processing in stage 205.

From stage 215, Method 200 may enter stage 225 where the content (e.g., as received from the user in the placeholder input fields) may be placed within the document based on the rules. In some embodiments, the user may first be prompted to initiate a command to begin the mapping of the content to the placeholder regions of document.

In some embodiments, prior to performing stage 225, method 200 may perform a sub-stage 220 and import an existing document (e.g., statement PDFs). For example, a user may have selected an existing statement PDF in the admin portal and, in response thereto, the DL platform may retrieve the existing statement PDF. The existing statement PDF may have already been previously processed in stages 205 and 210 of method 200 and subsequently stored for later retrieval.

From stage 225, method 200 may proceed to stage 235 where the DL platform may generate statement PDFs by combining the existing PDFs and templates. In this way, the color layer and the interactive layer may be applied to the existing statement PDF to create a new statement PDF.

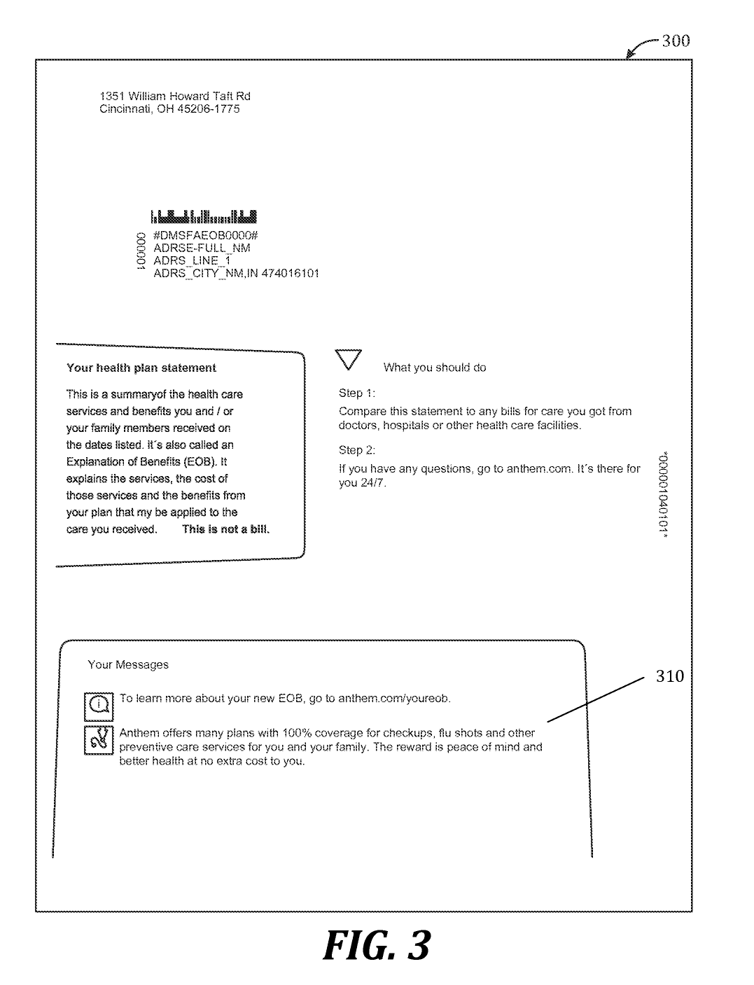

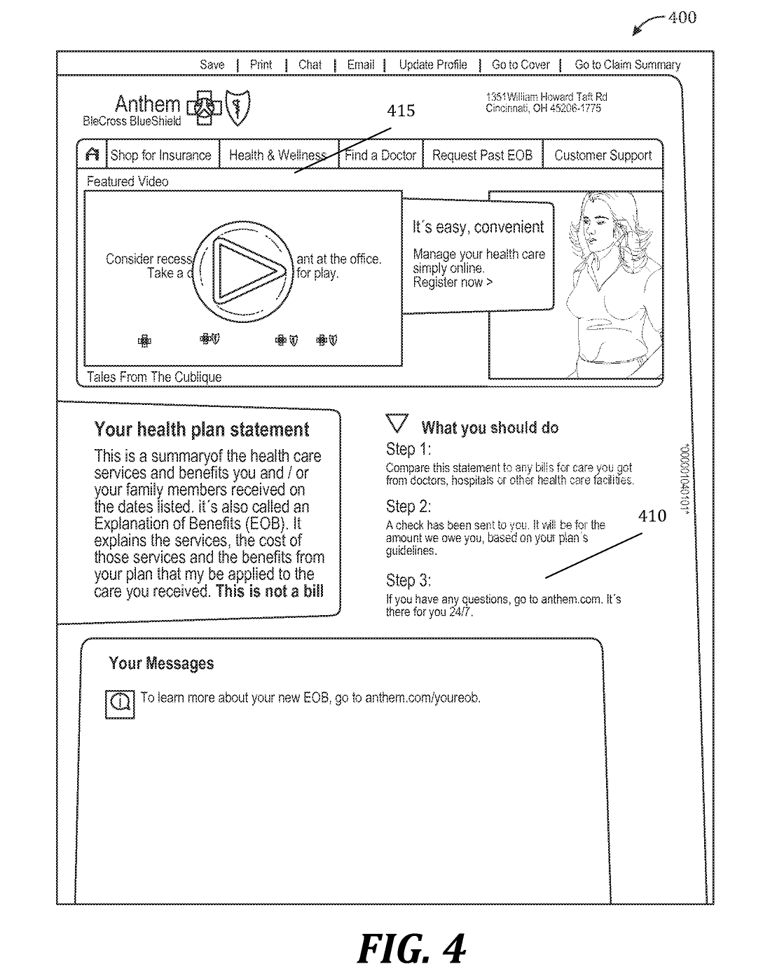

FIG. 3 illustrates an example of a legacy statement, i.e. an existing statement PDF. This legacy statement is entirely in black and white and does not have a modern look. FIG. 4 illustrates an example of the legacy statement of FIG. 3 that has undergone the layering process enabled by the DL platform.

In this embodiment, although not evident in the Black and White drawings, a template with a color layer and an interactive layer was applied to the legacy statement such that the new statement PDF of FIG. 4 now contains colored borders and images, as well as interactive elements such as an embedded video in now contained within the document. A copy of the color figure is available in the priority application U.S. Provisional Application No. 62/003,983, the contents of which is incorporated by reference herein.

Further, element 310 of FIG. 3 has been removed from processed FIG. 4, and element 410 has been added in FIG. 4. Interactive elements 415 have been added to the document, while other textual elements 410 and 310 have been added or removed.

IV. Platform Architecture

The DL platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the DL platform 100 may be hosted on a centralized server, such as, for example, a cloud computing service. Although method 200 has been described to be performed by a computing device 500, it should be understood that, in some embodiments, different operations may be performed by different networked elements in operative communication with computing device 500.

Embodiments of the present disclosure may comprise a system having a memory storage and a processing unit. The processing unit coupled to the memory storage, wherein the processing unit is configured to perform the stages of method 200.

FIG. 5 is a block diagram of a system including computing device 500. Consistent with an embodiment of the disclosure, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the disclosure.

With reference to FIG. 5, a system consistent with an embodiment of the disclosure may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include Document Layering Platform 520. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., DL Platform 520) may perform processes including, for example, one or more of method 200's stages as described above. The aforementioned process is an example, and processing unit 502 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a legacy document;
receiving at least one of the following: a color layer design and an interactive layer design;
overlaying the at least one of a color layer design and an interactive layer design onto the legacy document; and
outputting an updated document based on the legacy document and at least one of the following: the color layer design and the interactive layer design.

2. The method of claim 1, wherein receiving the legacy document may comprise receiving a PDF document.

3. The method of claim 1, wherein receiving the color layer design may comprise receiving at least one of the following:
a framing color,
a background color,
a portion of text,
an image,
a barcode,
a blank page, and
a colored image to replace a black and white image.

4. The method of claim 1, wherein receiving the interactive layer design may comprise receiving at least one of the following:
a response button,
a video,
an interactive onsert,
an interactive messaging application,
an interactive marketing application,
a URL, and
information.

5. The method of claim 1, further comprising at least one of the following:
parsing the legacy document for at least one data field;
mapping the at least one data field to a relational database; and
receiving the at least one data field from the relational database.

6. The method of claim 6, wherein parsing the document comprises locating white space and storing the location of the whitespace.

7. The method of claim 1, wherein receiving the legacy document comprises receiving a legacy document comprised of at least one data field that is mapped to a relational database.

8. The method of claim 1, wherein receiving the at least one of a color layer design and an interactive layer design comprises receiving a template.

9. The method of claim 1, further comprising providing a UI for receiving user input.

10. The method of claim 9, wherein the UI auto-populates input fields from parsed data.

11. The method of claim 9, wherein the UI receives a selection of at least one of the following:
the legacy document,
the at least one of a color layer design and an interactive layer design, and
rules for integrating content into document.

12. The method of claim 11, wherein the rules are associated with at least one of the following:
metadata within a template,
a file type, and
an external data source associated with the template.

13. The method of claim 1, further comprising triggering of the application, wherein the triggering may be initiated by at least one of the following:
receiving an input of information,
an indication of printing the legacy document, and
an indication of electronic communication of the legacy document.

14. The method of claim 13, wherein the triggering initiates a check to see if the document has been parsed, and if the document has not been parsed, initiates parsing.

15. The method of claim 1, further comprising:
receiving rules; and
applying the rules to overlay the at least one of the color layer design and the interactive layer design onto the legacy document.

16. A computer readable medium comprising a set of instructions which when executed perform a method comprising:
receiving a legacy document;
receiving at least one of the following: a color layer design and an interactive layer design;
overlaying at least one of the color layer design and the interactive layer design, onto the legacy document; and
outputting the legacy document containing at least one of the following: the color layer design and the interactive layer design.

17. The computer readable medium of claim 16, which when executed perform a method further comprising at least one of the following:
parsing the legacy document for at least one data field;
mapping the at least one data field to a relational database; and
receiving the at least one data field from the relational database.

18. A system comprising:
a memory storage; and
a processing unit coupled with the memory storage, wherein the processing unit is operative to:
receive a legacy document;
receive at least one of the following: a color layer design and an interactive layer design;
overlay the at least one of a color layer design and an interactive layer design, onto the legacy document; and
output the legacy document containing the received at least one of the following: a color layer design and an interactive layer design.

19. The system of claim 18, wherein the processing unit is further operative to at least one of the following:
parse the legacy document for at least one data field;
map the at least one data field to a relational database; and
receive the at least one data field from the relational database.
